(19) United States
(12) Patent Application Publication
(10) Pub. No.: US 2026/0353479 A1
(43) Pub. Date: Nov. 5, 2026

(54) METHOD FOR ESTABLISHING DATA PLANE CONNECTION AND DEVICE

(71) Applicant: VIVO MOBILE COMMUNICATION CO., LTD., Dongguan (CN)

(72) Inventor: Weiwei CHONG, Dongguan (CN)

(73) Assignee: VIVO MOBILE COMMUNICATION CO., LTD., Dongguan (CN)

(21) Appl. No.: 19/715,913

(22) Filed: Jun. 22, 2026

Related U.S. Application Data
(63) Continuation of application No. PCT/CN2024/140374, filed on Dec. 18, 2024.

(30) Foreign Application Priority Data
Dec. 22, 2023 (CN) 202311793534.X

(51) Int. Cl. H04W 76/10; H04L 61/4511; H04W 12/037; H04W 12/63

(52) U.S. Cl. CPC H04W 76/10; H04L 61/4511; H04W 12/037; H04W 12/63

(57) ABSTRACT

A method for establishing a data plane connection and a device performing the same, are provided. The method for establishing a data plane connection includes: receiving, by a first device, a first request message from a second device, and establishing, by the first device, a data plane connection with a target device based on the first request message.

### CROSS-REFERENCE TO RELATED APPLICATIONS

This application is a continuation of International Application No. PCT/CN 2024/140374, filed Dec. 18, 2024, which claims priority to Chinese Patent Application No. 202311793534.X, filed Dec. 22, 2023. The entire contents of each of the above-referenced applications are expressly incorporated herein by reference.

### TECHNICAL FIELD

This application relates to the field of communication technologies, and in particular, to a method for establishing a data plane connection and a device.

### BACKGROUND

In current discussions on 6G network architectures, the concept of a data plane has been proposed. The data plane includes data plane functions in a core network, a radio access network, and a terminal, and provides end-to-end connectivity. The data plane is responsible for data control, including data collection coordination, data collection configuration, data transmission configuration, and the like. The data plane is further responsible for functions such as data collection, data transmission, data preprocessing, data privacy and security, data analysis, data storage, and data services.

### SUMMARY

Embodiments of this application provide a method for establishing a data plane connection and a device.

According to a first aspect, a method for establishing a data plane connection is provided. The method includes:

A first device receives a first request message from a second device; and
the first device establishes a data plane connection with a target device based on the first request message.

According to a second aspect, a method for establishing a data plane connection is provided. The method includes:

A second device sends a first request message to a first device, where the first request message is used for establishing, by the first device, a data plane connection with a target device based on the first request message, or used for obtaining, by the target device, data from the first device based on the data plane connection.

According to a third aspect, an apparatus for establishing a data plane connection is provided. The apparatus includes:
a receiving module, configured to receive a first request message from a second device; and
a processing module, configured to establish a data plane connection with a target device based on the first request message.

According to a fourth aspect, an apparatus for establishing a data plane connection is provided. The apparatus includes:
a sending module, configured to send a first request message to a first device, where the first request message is used for establishing, by the first device, a data plane connection with a target device, or used for obtaining, by the target device, data from the first device based on the data plane connection.

According to a fifth aspect, a first device is provided. The first device includes a processor and a memory, where the memory stores a program or instructions executable on the processor, and when the program or the instructions are executed by the processor, steps of the method according to the first aspect are implemented.

According to a sixth aspect, a first device is provided. The first device includes a processor and a communication interface, where the communication interface is configured to receive a first request message from a second device, and the processor is configured to establish a data plane connection with a target device based on the first request message.

According to a seventh aspect, a second device is provided. The second device includes a processor and a memory, where the memory stores a program or instructions executable on the processor, and when the program or the instructions are executed by the processor, steps of the method according to the second aspect are implemented.

According to an eighth aspect, a second device is provided. The second device includes a processor and a communication interface. The communication interface is configured to: send a first request message to a first device, where the first request message is used for establishing, by the first device, a data plane connection with a target device, or used for obtaining, by the target device, data from the first device based on the data plane connection.

According to a ninth aspect, a readable storage medium is provided. The readable storage medium stores a program or instructions. When the program or the instructions are executed by a processor, steps of the method according to the first aspect or steps of the method according to the second aspect are implemented.

According to a tenth aspect, a wireless communication system is provided. The system includes a first device and a second device, where the first device is configured to perform steps of the method according to the first aspect, and the second device is configured to perform steps of the method according to the second aspect.

According to an eleventh aspect, a chip is provided. The chip includes a processor and a communication interface, where the communication interface is coupled to the processor, and the processor is configured to run a program or instructions to implement the method according to the first aspect or the method according to the second aspect.

According to a twelfth aspect, a computer program/a computer program product is provided. The computer program/the computer program product is stored in a storage medium, and the program/the program product is executed by at least one processor to implement steps of the method for establishing a data plane connection according to the first aspect or the second aspect.

According to embodiments of this application, a first device receives a first request message from a second device, and the first device establishes a data plane connection with a target device based on the first request message.

### BRIEF DESCRIPTION OF THE DRAWINGS

FIG. 1 is a diagram of an architecture of a wireless communication system according to an embodiment of this application;

FIG. 2 is a diagram of an architecture of a data plane according to an embodiment of this application;

FIG. 3 is a first schematic flowchart of a method for establishing a data plane connection according to an embodiment of this application;

FIG. 4 is a first schematic interaction flowchart of a method for establishing a data plane connection according to an embodiment of this application;

FIG. 5 is a second schematic interaction flowchart of a method for establishing a data plane connection according to an embodiment of this application;

FIG. 6 is a third schematic interaction flowchart of a method for establishing a data plane connection according to an embodiment of this application;

FIG. 7 is a second schematic flowchart of a method for establishing a data plane connection according to an embodiment of this application;

FIG. 8 is a first diagram of a structure of an apparatus for establishing a data plane connection according to an embodiment of this application;

FIG. 9 is a second diagram of a structure of an apparatus for establishing a data plane connection according to an embodiment of this application;

FIG. 10 is a diagram of a structure of a communication device according to an embodiment of this application;

FIG. 11 is a diagram of a structure of a terminal according to an embodiment of this application;

FIG. 12 is a first diagram of a structure of a network side device according to an embodiment of this application; and

FIG. 13 is a second diagram of a structure of a network side device according to an embodiment of this application.

### DETAILED DESCRIPTION

The following describes technical solutions in embodiments of this application with reference to the accompanying drawings in embodiments of this application. It is clear that the described embodiments are some rather than all of embodiments of this application. All other embodiments obtained by a person of ordinary skill in the art based on embodiments of this application fall within the protection scope of this application.

The terms “first,” “second,” and the like in this application are used to distinguish similar objects, but are not used to describe a specific order or sequence. It should be understood that the terms used in this way are interchangeable in a proper case, so that embodiments of this application can be implemented in other orders than the order illustrated or described herein. In addition, objects distinguished by “first” and “second” are usually of a same type, without limiting a quantity of objects. For example, there may be one or more first objects. In addition, the term “or” in this application indicates at least one of connected objects. For example, “A or B” covers three solutions, that is, solution 1: A is included, and B is not included; solution 2: B is included, and A is not included; and solution 3: both A and B are included. The character “/” generally indicates an “or” relationship between associated objects.

In this application, the term “indication” may be a direct indication (or referred to as an explicit indication) or an indirect indication (or referred to as an implicit indication). The direct indication may be understood as that a sending party explicitly notifies a receiving party of content such as specific information, an operation that needs to be performed, or a request result in a sent indication. The indirect indication may be understood as that the receiving party determines corresponding information based on an indication sent by the sending party, or performs determining and determines an operation that needs to be performed or a request result based on a determining result.

It should be noted that the technologies described in embodiments of this application are not limited to a Long Term Evolution (LTE)/LTE-Advanced (LTE-A) system, and may also be used in another wireless communication system, for example, Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), or another system. The terms “system” and “network” in embodiments of this application are often used interchangeably, and the described technologies can be used for the systems and radio technologies mentioned above, and can also be used for other systems and radio technologies. The following descriptions describe a New Radio (NR) system for illustrative purposes and use the term NR for most of the following descriptions. However, these technologies may also be used in systems other than the NR system, such as a 6th Generation (6G) communication system.

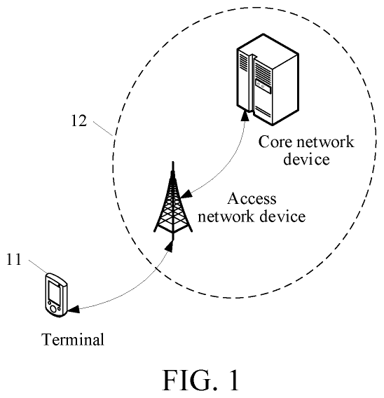

FIG. 1 is a block diagram of a wireless communication system to which an embodiment of this application may be applied. The wireless communication system includes a terminal 11 and a network side device 12. The terminal 11 may be a mobile phone, a Tablet Personal Computer (Tablet PC), a Laptop Computer, a notebook computer, a Personal Digital Assistant (PDA), a palmtop computer, a netbook, an Ultra-Mobile Personal Computer (UMPC), a Mobile Internet Device (MID), an Augmented Reality (AR) device, a Virtual Reality (VR) device, a robot, a Wearable Device, a flight vehicle, Vehicle User Equipment (VUE), a ship-borne device, Pedestrian User Equipment (PUE), a smart home appliance (a home device having a wireless communication function, for example, a refrigerator, a television, a washing machine, or furniture), and terminal-side devices such as a game console, a Personal Computer (PC), a teller machine, or a self-service machine. The wearable device includes a smart watch, a smart band, a smart earphone, smart glasses, smart jewelry (a smart bracelet, a smart chain, a smart ring, a smart necklace, a smart anklet, a smart ankle chain, or the like), a smart wristband, smart clothing, or the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in embodiments of this application. The network side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AP), a Wireless Fidelity (Wi-Fi) node, or the like. The base station may be referred to as a NodeB (NB), an Evolved NodeB (eNB), a next generation NodeB (gNB), a New Radio NodeB (NR NodeB), an access point, a Relay Base Station (RBS), a Serving Base Station (SBS), a Base Transceiver Station (BTS), a radio base station, a radio transceiver, a Basic Service Set (BSS), an Extended Service Set (ESS), a Home NodeB (HNB), a home evolved NodeB, a Transmission Reception Point (TRP), or another appropriate term in the art. Provided that the same technical effect is achieved, the base station is not limited to a specific technical term. It should be noted that, in embodiments of this application, a base station in an NR system is merely used as an example, and a specific type of the base station is not limited.

The core network device may include, but is not limited to, at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), and the like. It should be noted that a core network device in an NR system is merely used as an example for description, and a specific type of the core network device is not limited in embodiments of this application.

The following first describes technical terms and application scenarios in embodiments of this application.

When a network side device needs to establish a data plane connection with a terminal to obtain data in the terminal, there may be a plurality of potential paths. For example, the data plane connection may be based on a user plane path (user plane protocol stack) or a control plane path (control plane protocol stack). In some implementations, the data plane connection may also be based on a newly defined data plane path (data plane protocol stack). However, how the terminal and the network side device determine and negotiate to select one of the paths to carry the data plane connection is unclear at present.

For data transmission on the data plane connection between the terminal and the network side device, there may be a plurality of data encoding schemes based on data serialization schemes such as JavaScript Object Notation (JSON), Abstract Syntax Notation One (ASN.1), Protocol Buffer (Protobuf), Extensible Markup Language (XML), Yet Another Markup Language (YAML), MessagePack, and Binary JSON (BSON), and each scheme has distinct characteristics, as specifically described below.

JSON is a lightweight data interchange format, easy to read and write, supports a plurality of programming languages, and is usually used in a Web (Web) application. However, JSON is text-based, resulting in low efficiency in data encoding and transmission.

ASN.1 has advantages such as compact encoding, secure type, and good interoperability, but requires a dedicated encoding and decoding tool and rule, and is difficult to implement.

Protocol Buffer is an efficient binary serialization format, supports a plurality of programming languages, and is usually used in a large-scale distributed system.

XML is a markup language used for describing data, supports a plurality of programming languages, and is usually used in a Web application and for data exchange.

YAML is a human-readable data serialization format used for a configuration file and data exchange, and supports a plurality of programming languages.

MessagePack is an efficient binary serialization format, supports a plurality of programming languages, and is faster and smaller than JSON.

BSON is a binary JSON format, supports more data types and has better performance, and is usually used in a MongoDB database.

However, it is also unclear how the terminal and the network side device negotiate to select a data encoding scheme according to different requirements.

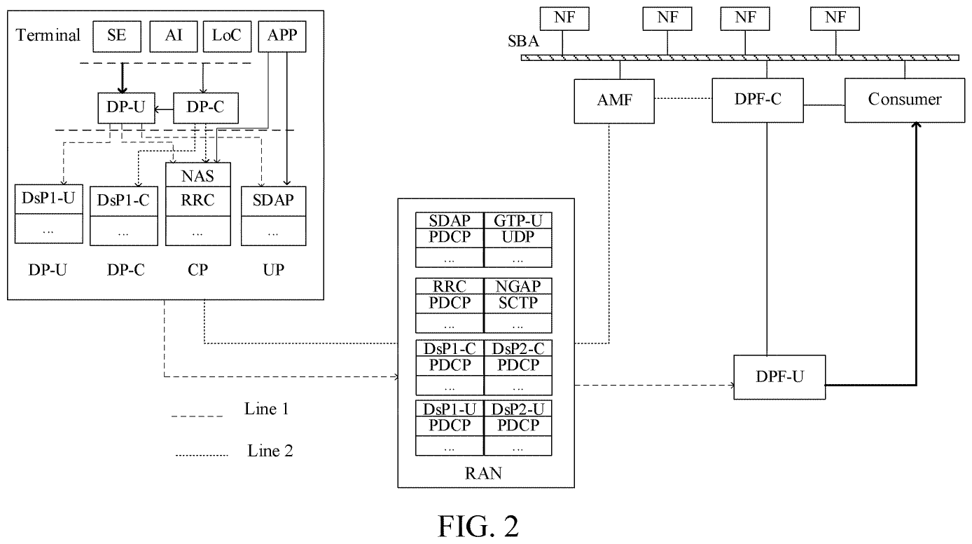

FIG. 2 shows an architecture of a data plane, including a Data Plane (DP) connection between a terminal and a network side device. For example, the terminal is a data source (data source).

A DP-C and a DP-U are two modules related to the data plane in the terminal.

1. The DP-C is a data plane control module, configured to control signaling related to data plane establishment, modification, and deletion.

2. The DP-U is a data plane forwarding module, configured to collect, process, and forward terminal-related data.

Correspondingly, on a core network side, there is a corresponding network element (for example, a Data Plane Function (DPF)) corresponding to the foregoing two modules in the terminal.

1. A DPF-C is a data plane control network element, configured to control signaling related to data plane establishment, modification, and deletion.

2. A DPF-U is a data plane forwarding network element, configured to collect, process, and forward data related to the terminal, a RAN, or another data source.

It should be noted that the network element on the core network side may be referred to by other network element names, or replaced with other network elements having similar functions, for example, a Data Collection Coordination Function (DCCF) network element, or a Messaging Framework Adaptor Function (MFAF) network element.

Data plane-related signaling of the terminal (that is, signaling controlled by the DP-C module) may interact with the DPF-C on the core network side based on different protocol stacks, for example, as shown by line 2 in FIG. 2:
1. based on an existing CP protocol stack (for example, a Non-Access Stratum (NAS) protocol layer and an underlying Access Stratum (AS) protocol layer); and
2. based on an added DP protocol stack (for example, a Data stratum Protocol 1 (DsP1) and a Packet Data Convergence Protocol (PDCP), where the DsP1 is a peer protocol layer in the data plane between the terminal and the RAN).

It should be noted that the DP protocol stack between the terminal and a network side may be over or not over the DsP1 protocol layer.

When the DP protocol stack is over the DsP1 protocol layer, the RAN may parse the DsP1 protocol layer, and may obtain and parse a part or all of information in data transferred by the terminal to the core network side, helping a data plane module in the RAN to obtain related information.

When the DP protocol stack is not over the DsP1 protocol layer, the RAN transparently transmits the data transferred by the terminal to the core network side.

Similarly, data forwarding on the data plane of the terminal (that is, data processed by the DP-U module) may interact with the DPF-U on the core network side based on different protocol stacks, for example, as shown by line 1 in FIG. 2:
1. based on a CP protocol stack (for example, a NAS protocol layer and an underlying AS protocol layer);
2. based on a UP protocol stack (for example, a Service Data Adaptation Protocol (SDAP) or PDCP); and
3. based on a DP protocol stack (for example, DsP1 or PDCP, where the DsP1 is a peer protocol layer in the data plane between the terminal and the RAN).

The DP protocol stack is a newly defined protocol stack dedicated to the data plane, and conforms to new characteristics of data plane data transmission, such as massive data transmission, large bandwidth, large data segments, simple encapsulation formats, and lightweight encryption.

In some implementations, DsP1-C and DsP1-U in FIG. 2 may be omitted.

In some implementations, DsP1-C and DsP1-U may be combined.

In some implementations, a DP-U path and a DP-C path may be combined.

In some implementations, in FIG. 2, by way of example, the DP-C and the DP-U are separated, and the DPF-C and the DPF-U are also separated; however, in practice, the DP-C and the DP-U may be co-deployed, and the DPF-C and the DPF-U may also be co-deployed.

In some implementations, the Data Source in embodiments of this application includes at least one of the following: a terminal, a RAN, a Core Network Network Function (CN NF), Operation Administration and Maintenance (OAM), a data repository network element (for example, an Analytics Data Repository Function (ADRF)), an Application Function (AF), or the like. Modules that generate data in the terminal include, but are not limited to, service data modules such as sensing, Artificial Intelligence (AI), and location, as well as basic common data modules. A data source in the RAN may include an access network data plane device. A data source in the CN includes, but is not limited to, a sensing function, a data storage function (data storage, for example, ADRF), an AI-related device (for example, a NetWork Data Analytics Function (NWDAF)), and the like. A data source in the AF includes, but is not limited to, a trusted AF, a non-trusted AF, and the like. The data source includes a data source (for example, the CN NF or the OAM) that accesses a service-based architecture and a source (for example, the terminal or the RAN) that does not access the service-based architecture.

A data consumer includes at least one of the following: a terminal, a RAN, a CN NF, OAM, an ADRF, an AF, or the like. The data consumer includes a consumer (for example, the CN NF or the OAM) that accesses a service-based architecture and a consumer (for example, the terminal or the RAN) that does not access the service-based architecture.

In some implementations, the architecture in embodiments of this application may not be fully service-based, that is, some devices or network elements (for example, the terminal, the RAN, and some AFs) may not be service-based, and the devices or the network elements still communicate with other devices (including a service-based architecture (Service-based architecture, SBA) network element) in a network via a point-to-point interface.

For example, when the terminal is used as the data source, in a process of establishing a data plane connection between the terminal, an access network device, and a core network (CN), how to agree on paths and processing schemes for signaling and data transfer, and the like, so that a data plane network element in the CN can obtain corresponding data from the terminal appropriately and efficiently, is a problem that needs to be resolved.

The following describes in detail a method for establishing a data plane connection provided in embodiments of this application by using some embodiments and application scenarios thereof with reference to accompanying drawings.

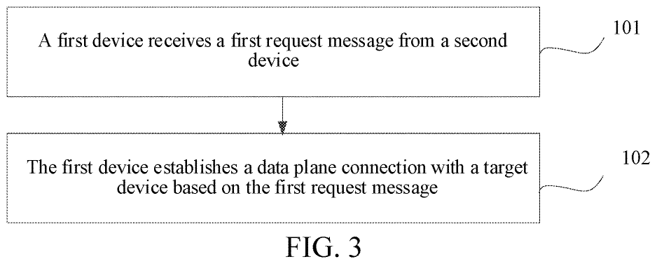

Refer to FIG. 3. An embodiment of this application provides a method for establishing a data plane connection. This embodiment is executed by a first device, and the method includes the following steps.

Step 101: The first device receives first request message from a second device.

Step 102: The first device establishes a data plane connection with a target device based on the first request message.

In some implementations, the first device includes at least one of a terminal and an access network device.

In some implementations, the second device includes at least one of an access network device and a core network device.

In some implementations, the target device includes at least one of an access network device and a core network device.

Specifically, the second device may send the first request message to the first device based on a data request of a data consumer device. The first request message is used for requesting to establish the data plane connection between the first device and the target device, or used for obtaining data based on the data plane connection.

In some implementations, establishing the data plane connection may be selecting a path from an existing path between the first device and the target device and establishing the data plane connection, or directly creating a path between the first device and the target device and establishing the data plane connection. The first device establishes the data plane connection with the target device based on the first request message. In some implementations, the target device may be the second device, or another device in a network domain to which the second device belongs, for example, another network element in a core network.

For example, the first device is a terminal, the second device may be a core network device (for example, a DPF-C), and the target device may be a core network device (for example, a DPF-U); or the first device is an access network device, the second device is a core network device (for example, a DPF-C), and the target device is a core network device (for example, a DPF-U).

For example, when the first device is a terminal, the second device may be an access network device, and the target device may be an access network device or a core network device.

According to the method in this embodiment, the first device receives the first request message from the second device, and the first device establishes the data plane connection with the target device based on the first request message, so that the data plane connection between the first device and the target device is established with low implementation complexity.

In some implementations, the first request message includes at least one of the following: first path information for data plane control signaling; second path information for forwarding data plane data; a first data encoding scheme; and a first data encryption scheme.

Specifically, the first path information, the second path information, the first data encoding scheme, and the first data encryption scheme that are included in the first request message may be selected or determined by the second device.

Descriptions are provided below by using an example in which the first device is a terminal, and the second device is a core network device. For example, the second device is a DPF.

1. The first path information for the data plane control signaling selected by the DPF indicates, to the terminal, information about a first path preferred by the DPF-C, and the first path is used for transferring data plane-related control signaling.

In some implementations, the first path may be represented as a CP-plane path and a data plane control DP-C path. In some embodiments, the first path may be represented as a protocol layer through which data plane signaling is transferred (for example, sequentially, NAS-PDCP-Layer 2 protocol-Layer 1 protocol, or DsP1-C-PDCP-Layer 2 protocol-Layer 1 protocol).

2. The second path information for forwarding the data plane data selected by the DPF indicates, to the terminal, information about a second path preferred by the DPF-U, and the second path is used for forwarding the data plane data.

In some implementations, the second path may be represented as a CP-plane path, a UP-plane path, and a data plane forwarding DP-U-plane path. In some embodiments, the second path may be represented as a protocol layer through which the data plane data is forwarded (for example, NAS-PDCP-Layer 2 protocol-Layer 1 protocol; or SDAP-PDCP-Layer 2 protocol-Layer 1 protocol; or DsP1-U-PDCP-Layer 2 protocol-Layer 1 protocol).

3. The first data encoding scheme selected by the DPF includes, but is not limited to, a data serialization scheme used by the terminal when reporting data, for example, ASN.1, Protobuf, and JSON.

4. The first data encryption scheme selected by the DPF includes, but is not limited to, indicating whether data reported by the terminal needs to be encrypted.

In the foregoing implementations, the first request message includes at least one of the following: the first path information for the data plane control signaling; the second path information for forwarding the data plane data; the first data encoding scheme; and the first data encryption scheme. In this way, the data plane connection between the first device and the target device may be established with low implementation complexity.

In some implementations, the data consumer device (Data consumer) (for example, another terminal, a service function (Service Function, SF), or an AF) requests, for example, by using a second request message, to obtain data from the second device (for example, the DPF-C). The second request message may include at least one of the following:
a service type or an identifier, for example, a sensing service (sensing service), a location service (location service), or an application identifier (APP ID);
a type or an identifier of to-be-obtained data, for example, a data type (data type) or an event identifier (event ID);
a data object, for example, a specific terminal, a terminal list, a terminal group, or any terminal in an area of interest (AOI);
a data scope, defining a time range, an area range, and the like for obtaining data;
a data reporting condition; and
other information.

In some implementations, the second device (for example, the DPF-C) responds to a request from the data consumer device, and a response message indicates whether the request from the data consumer device for obtaining data is accepted. If the request is rejected, a procedure ends.

It should be noted that the DPF-C may be a newly defined network element, or may be an existing network element in 5G that is responsible for data collection, for example, a data collection coordination function (Data Collection Coordination Function, DCCF) network element.

In some implementations, the first request message may be a first request message from the second device that is forwarded by another device, for example, a downlink NAS message sent to the first device through an AMF, where content of the first request message is carried in the downlink NAS message.

In some implementations, the second device may send the first request message to the AMF through Namf_Communication_N1N2MessageTransfer signaling.

In some implementations, the method further includes:

The first device determines first information based on the first request message; and
that the first device establishes a data plane connection with a target device based on the first request message includes:

The first device establishes the data plane connection with the target device based on the first information, where
the first information includes at least one of the following: third path information for data plane control signaling; fourth path information for forwarding data plane data; a second data encoding scheme; and a second data encryption scheme.

Specifically, after receiving the first request message, the first device determines the first information based on the first request message, and establishes the data plane connection with the target device based on the first information.

In some implementations, the first path information or the third path information includes at least one of the following: control plane path indication information, user plane path indication information, data plane control path indication information, or information about a protocol layer through which data plane signaling is transferred.

In some implementations, the second path information or the fourth path information includes at least one of the following: control plane path indication information, user plane path indication information, data plane forwarding path indication information, or information about a protocol layer through which the data plane data is forwarded.

The control plane path indication information may be, for example, related information of a CP path, the user plane path indication information may be, for example, related information of a UP path, the data plane control path indication information may be related information of a DP-C path, and the data plane forwarding path indication information may be related information of a DP-U path. It may be understood that the control plane path indication information may be information indicating a CP path, the user plane path indication information may be information indicating a UP path, the data plane control path indication information may be information indicating a DP-C path, and the data plane forwarding path indication information may be information indicating a DP-U path.

In some implementations, the first path information and the third path information may be the same or different, and the second path information and the fourth path information may be the same or different.

In some implementations, that the first device determines first information based on the first request message includes:

The first device determines the third path information for the data plane control signaling based on a first factor, where the first factor includes at least one of the following:
a forwarding latency requirement for the data plane control signaling; and
whether the data plane control signaling needs to be parsed by an access network device.

Specifically, the first device determines the third path information for the data plane control signaling based on the first factor. The first factor includes at least one of the following:
(1) the forwarding latency requirement for the data plane control signaling, where for example, when a latency requirement is high, a path for the data plane control signaling needs to be simplified in terms of a protocol layer and bypass encryption and decryption, and in this case, a protocol stack corresponding to a newly defined simplified DP path or a CP protocol stack may be used; or conversely, a UP protocol stack may be used for the path for the data plane control signaling; and
(2) whether the data plane control signaling needs to be parsed by the access network device RAN, where for example, when the data plane control signaling needs to be parsed by the RAN, the signaling needs to be processed by a peer protocol layer in a data plane of the RAN (for example, DsP, DsP1, PDCP, Layer 2 protocol, and Layer 1 protocol; or DsP, DsP1, RRC, PDCP, Layer 2 protocol, and Layer 1 protocol); or conversely, the signaling does not need to be processed by a peer protocol layer in a data plane of the RAN (for example, DsP, PDCP, Layer 2 protocol, and Layer 1 protocol; or DsP, NAS, RRC, PDCP, Layer 2 protocol, and Layer 1 protocol).

In some implementations, the first device may determine the third path information based on the first request message and the first factor, for example, based on the first path information in the first request message and the first factor.

In some implementations, that the first device determines first information based on the first request message includes:

The first device determines the fourth path information for forwarding the data plane data based on a second factor, where the second factor includes at least one of the following:
a latency requirement for obtaining the data plane data;
an amount of to-be-transmitted data; and
whether the data plane data needs to be parsed by an access network device.

Specifically, the first device determines the fourth path information for forwarding the data plane data based on the second factor. The second factor includes at least one of the following:
(1) the latency requirement for obtaining the data plane data, where for example, when required latency for obtaining the data plane data is less than a preset threshold, the first device selects a CP path as a data forwarding path;
(2) the amount of to-be-transmitted data, where for example, when the amount of data is greater than a preset threshold, the first device selects a UP path as a data forwarding path; and
(3) whether the data plane data needs to be parsed by the RAN, where for example, when the data plane data needs to be obtained and parsed by a data plane function on an RAN side, the first device selects a DP path. In some implementations, encapsulation and parsing processing on a DsP1 protocol layer further need to be performed on the DP path.

In some implementations, the first device may determine the fourth path information based on the first request message and the second factor, for example, based on the second path information in the first request message and the second factor.

In some implementations, that the first device determines first information based on the first request message includes:

The first device determines the second data encoding scheme based on a third factor, where the third factor includes at least one of the following:
an encoding latency requirement for the data plane data;
an encoding efficiency requirement for the data plane data;
a readability requirement for the data plane data;
a security requirement for the data plane data; and
a reliability requirement for the data plane data.

Specifically, the first device determines the second data encoding scheme based on the third factor. The third factor includes at least one of the following:
(1) the encoding latency requirement for the data plane data, where for example, when an encoding latency requirement is high, the first device may select a serialization scheme (for example, Protocol Buffer) corresponding to binary encoding;
(2) the encoding efficiency requirement for the data plane data, where for example, when an encoding efficiency requirement is high, the first device may select a serialization scheme (for example, Protocol Buffer) corresponding to binary encoding;
(3) the readability requirement for the data plane data, where for example, when high human readability of data is required, the first device may select a text-based data serialization scheme (for example, JSON or XML);
(4) the security requirement for the data plane data, where for example, when data transmission requires a certain level of security, the first device may select an ASN.1-based serialization scheme; and
(5) the reliability requirement for the data plane data, where for example, when data transmission requires a certain level of reliability, the first device may select an ASN.1-based serialization scheme.

In some implementations, the first device may determine the second data encoding scheme based on the first request message and the third factor, for example, based on the first data encoding scheme in the first request message and the third factor.

In some implementations, the first device may determine the second data encryption scheme, for example, determine whether to encrypt or not encrypt, or determine an encryption scheme based on a latency requirement, a security requirement, or the like. In some embodiments, the first device may determine the second data encryption scheme based on the first data encryption scheme in the first request message, a latency requirement, a security requirement, or the like.

In the foregoing implementations, the first device determines the first information based on the first request message, and further establishes the data plane connection with the target device based on the first information. In other words, after receiving the first request message, the first device may determine the first information with reference to at least one of the first request message, the first factor, the second factor, and the third factor.

In some implementations, that a first device receives a first request message from a second device includes:

A data plane control module of the first device receives the first request message from the second device.

That the first device determines first information based on the first request message includes:

The data plane control module of the first device determines the first information based on the first request message; and
the data plane control module of the first device forwards the first information to a data plane forwarding module of the first device.

That the first device establishes a data plane connection with a target device based on the first request message includes:

The data plane forwarding module of the first device establishes the data plane connection with the target device based on the first information.

Specifically, an interaction process occurs between data plane-related modules in the first device, including at least one of the following.

The data plane control module DP-C receives content of the first request message;
the DP-C determines, based on the content of the first request message and at least one of the first factor, the second factor, or the third factor, the first information selected by the first device, where the first information includes at least one of the following: the third path information for the data plane control signaling, the fourth path information for forwarding the data plane data, the second data encoding scheme, and the second data encryption scheme;
the DP-C sends the first information selected by the first device to the data plane forwarding module DP-U of the first device, where the first information includes at least one of the following: path information for forwarding the data plane data, a data encoding scheme, and a data encryption scheme; and
the DP-U establishes the data plane connection with the target device based on the first information.

In some implementations, the first request message further includes at least one piece of the following information about the data plane data:
a type of collected data;
data filtering information, used for performing filtering during data collection to obtain needed data;
data reporting condition information;
a data processing scheme; and
a data storage format, where
the data filtering information includes at least one of the following:
location restriction information for a data collection object;
time restriction information for data collection; and
service or application restriction information, used for restricting a service or an application that generates data; and
the data reporting condition information includes at least one of the following:
time periodicity information for data reporting; and
event information for triggering data reporting.

Specifically, the first request message may further include other information, for example:
(1) a data type, for example, represented by a data type list (Data type list), and indicating a type of to-be-collected data, where specifically, the data type indicates a specific type of to-be-collected data, and may be provided in a form of a list, for example, collected data includes, but is not limited to, service data such as sensing, AI, and location (location) in the terminal, and basic common data;
(2) data filtering information (Data filter (location (location), time (time), service, application, or the like)), indicating a scope and a condition for data collection, where needed data may be further obtained through filtering based on a set filtering parameter, and the data filtering information includes at least one of the following:
(2-1) location restriction information (location), used for restricting a location of a data collection object when data is generated, where the location restriction information may be at a granularity of, for example, a cell (cell) or a tracking area (Tracking Area, TA), or at a granularity of, for example, latitude and longitude, and for example, when a value of the location restriction information is a cell area, during data collection, the terminal collects only data generated by a data collection object in the cell area;
(2-2) time restriction information (time), used for restricting data generation time, including collection start time and collection end time, where for example, if the time restriction information specifies collection start time of 08:00 and collection end time of 18:00, during data collection, the terminal collects only data generated within this time period; and
(2-3) service or application restriction information (application), used for restricting a service or an application that generates data, where the service or application restriction information includes, for example, name information of the service or the application and identification information of the service or the application, and for example, when a value of the application restriction information is “xx Music”, during data collection, the terminal collects only data generated by this application;
(3) data reporting condition information (Data reporting info), indicating condition information for data reporting, where the data reporting condition information includes at least one of the following:
(3-1) time periodicity information for data reporting, indicating that data collected within a preset time period is to be reported according to a specific time periodicity, where the time periodicity is set, and for example, if a value of the time periodicity information is set to daily, the terminal reports data collected on the current day every day; and
(3-2) event information for triggering data reporting, indicating that the terminal reports data when target time is reached or when a condition of a target event is satisfied, where for example, the event information may include: an amount of data reaches a threshold at a specific time point, or the terminal moves to a target location;
(4) data processing scheme, indicating how data is to be finally processed before being stored in a network, where for example, if data expected by the network is a maximum value in a specific period of time, a maximum value is first determined from collected data and then the maximum value is uploaded, and other data processing schemes may include: averaging, variance calculation, minimum value determining, mean normalization, normalization, and the like; and
(5) data storage format, indicating a format in which data is finally stored in a network, where for example, if the network expects data to be stored in an integer format, collected data of a decimal/floating-point type needs to be converted into an integer before being stored, and other data storage formats may include: integer, decimal, floating-point, 16-bit floating-point, 8-bit floating-point, string, and the like.

In some implementations, the foregoing particular information related to requested data may be included in the first request message for sending, or may be included in another subsequent request message for sending. This is not limited in embodiments of this application.

In some implementations, the first request message is determined by the second device based on at least one of data collection policy information for a data plane corresponding to the first device, a data request sent by a data consumer device, or requirement information of the second device.

In some implementations, the requirement information of the second device may include at least one of the first factor, the second factor, or the third factor.

Specifically, the second device (for example, the DPF-C) and a third device (for example, a policy control network element (for example, a PCF)) establish/modify a data collection policy association (data collection policy association) of the data plane corresponding to the first device.

Specifically, the second device determines to establish a data collection policy for the data plane corresponding to the first device;
the second device sends a policy association establishment request to the third device; and
the third device feeds back, to the second device, requested data collection policy information for the data plane corresponding to the first device.

In some implementations, the second device obtains the data collection policy information from the third device.

The data collection policy information includes at least one of the following:
data status;
anonymity indication information, indicating whether collected data is in an anonymous state;
a path type for data reporting, indicating a path type accepted or supported by the first device for data reporting;
an encoding scheme for data reporting; and
an encryption scheme for data reporting.

The data collection policy information for the data plane corresponding to the first device may indicate how the second device (for example, the DPF-C or the DPF-U) collects data. The data collection policy information for the data plane corresponding to the first device includes at least one of the following:
data status, indicating status of collectable data, that is, whether the data is raw data (Raw data) or processed data (processed data). Raw data is data that has not undergone any processing and is kept in a format in which the data is collected. The processed data is data that has undergone data preprocessing. Operations of data preprocessing may include data cleaning, data integration, data reduction, data transformation, and the like.

The anonymity indication information indicates whether the collected data is in the anonymous state. If data is in the anonymous state, data collected by the second device may include only the data, without information indicating the first device or a user to which the data belongs. Identification information corresponding to the data may be a processed first device identifier or identification information mapped by a network element. An anonymization step may be performed by the first device during reporting, or may be performed during reporting by the second device or a specific network element.

The path type for data reporting indicates a path type accepted or supported by the first device for data reporting, for example, reporting via a user plane (User plane, UP), a control plane (Control Plane, CP), a data plane (data plane, DP), or the like.

The encoding scheme for data reporting indicates, but is not limited to, a data serialization scheme used by the first device during data reporting, for example, ASN.1, Protocol Buffer, and JSON.

The encryption scheme for data reporting includes, but is not limited to, an indication of whether data reported by the first device needs to be encrypted.

In some implementations, the method further includes:

The first device sends data to the target device based on the data plane connection.

In some implementations, that the first device sends data to the target device based on the data plane connection includes:

A data plane forwarding module of the first device sends the data to the target device based on the data plane connection.

Specifically, when receiving the first request message, the first device performs data collection. For example, the first device is a terminal, and the DP-U performs data processing based on the first information indicated by the DP-C.

For example, the terminal determines a type of to-be-collected data based on a data type and the like, and the DP-U collects service data from a higher layer or obtains basic common data from another layer (for example, RRC). Further, data collection scope needs to conform to data filtering scope included in the first request message.

In some implementations, that the first device sends data to the target device based on the data plane connection includes:

The first device sends the data to the target device based on the fourth path information for forwarding the data plane data.

In some implementations, before the sending the data to the target device, the method further includes at least one of the following:

The first device encodes the data based on the second data encoding scheme; and
the first device encrypts the data based on the second data encryption scheme.

Specifically, the DP-U determines an appropriate path for forwarding the data plane data based on the fourth path information for forwarding the data plane data indicated by the DP-C. For example, the data may be sent via a UP path, a CP path, or a DP path. It should be noted herein that selecting a data plane forwarding path may also be equivalent to selecting a protocol layer through which the data is forwarded.

In some implementations, before forwarding the data, the DP-U performs data encoding on the collected data based on the second data encoding scheme indicated by the DP-C, for example, specifically by serializing the data by using ASN.1, protobuf, JSON, or the like.

In some implementations, before forwarding the data, the DP-U decides, based on the second data encryption scheme indicated by the DP-C, whether to start an encryption process for the data.

In some implementations, the first device is a terminal. If the terminal is in an idle state, the terminal may trigger a service request process, to enter a connected state. A main objective is to send an uplink signaling message, user data, and the like.

In some implementations, the first device sends the data to the second device via the data plane data forwarding path selected by the first device.

For example, the DP-U forwards the data plane data via the CP path. The DP-U processes the collected data based on a selected data processing scheme, and then the data is encapsulated layer by layer through a protocol stack corresponding to the CP path before being sent outward. Forwarded by the RAN and the AMF, the data arrives at the DPF-C network element, and the DPF-C network element forwards the data to the DPF-U network element.

In some implementations, the DPF-U stores the collected data.

In some implementations, the DPF-U feeds back requested data to the data consumer device.

In some implementations, that the first device sends the data to the target device based on the fourth path information for forwarding the data plane data includes:

The first device sends the data to the target device based on the fourth path information for forwarding the data plane data and based on second information, where
the second information includes at least one of the following: address information, identification information, and port information of the target device.

In some implementations, the second information is obtained by the first device from the second device; or
the second information is obtained by the first device through a domain name system (DNS) query.

Specifically, before sending the data to the target device (for example, the DPF-U) via the UP path, the first device (for example, the DPF-U module of the terminal) needs to learn at least one of the address information, the identification information, and the port information of the target device.

In some implementations, a manner for obtaining the second information includes, but is not limited to, any one of the following:
(a) The second information is obtained by the first device from the second device. For example, the first request message sent by the DPF-C to the terminal carries at least one of the address information, the identification information, and the port information of the target device (for example, the DPF-U).
(b) The first device obtains at least one of the address information, the identification information, and the port information of the target device (for example, the DPF-U) through the DNS query.

In some implementations, the method further includes:

The first device sends a response message to the first request message to the
second device, where the response message to the first request message includes at least one of the following:
third path information for data plane control signaling;
fourth path information for forwarding data plane data;
a second data encoding scheme; and
a second data encryption scheme.

Specifically, the first device sends the response message to the first request message to the second device, where the response message indicates whether the first device accepts the first request message. In some implementations, for example, the response message is carried in an uplink NAS message. For example, the first device sends the response message to the second device via the third device (for example, the AMF).

If the first device accepts the first request message, the response message may include at least one of the following:
third path information for data plane control signaling selected by the first device;
fourth path information for forwarding data plane data selected by the first device;
a second data encoding scheme selected by the first device; and
a second data encryption scheme selected by the first device.

For example, the third path information and the fourth path information include the CP path or information about a protocol stack corresponding to the CP path, that is, the data plane connection is based on the control plane path; the third path information and the fourth path information include the UP path or information about a protocol stack corresponding to the UP path, that is, the data plane connection is based on the user plane path; or the third path information and the fourth path information include a DP forwarding path or information about a protocol stack corresponding to the DP forwarding path, that is, the data plane connection is based on the data plane forwarding path.

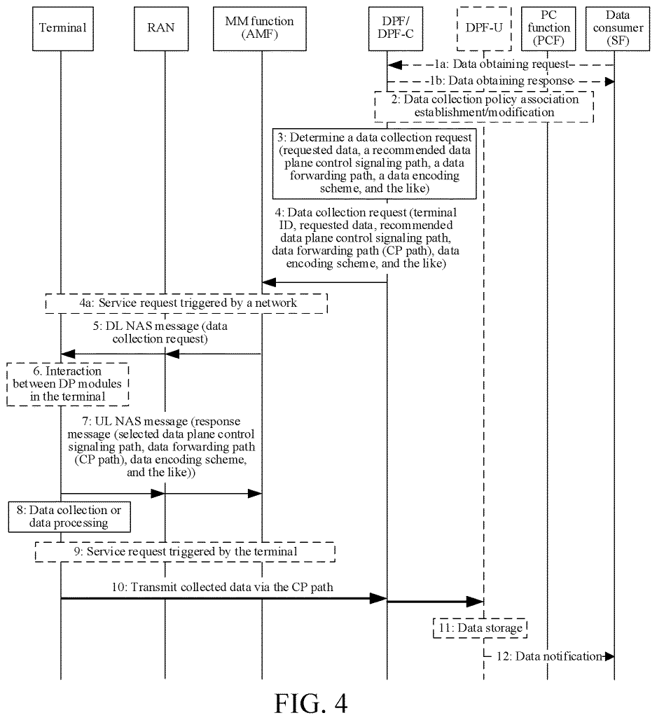

For example, as shown in FIG. 4, an MM function is a mobility management (Mobility Management, MM) function, and a PC function is a policy control (Policy Control, PC) function. The method includes:
Step 1a: The data consumer device sends a data obtaining request to the DPF (or the DPF-C).
Step 1b: The DPF (or the DPF-C) sends a data obtaining response to the data consumer device.
Step 2: Data collection policy association establishment/modification (data collection policy association establishment/modification).
Step 3: The DPF (or the DPF-C) determines a data collection request. For example, the data collection request includes at least one of the following: requested data, a recommended data plane control signaling path, a data forwarding path, a data encoding scheme, a data encryption scheme, and the like.
Step 4: The DPF (or the DPF-C) sends the data collection request to the AMF. For example, the data collection request includes at least one of the following: a terminal ID, the requested data, the recommended data plane control signaling path, the data forwarding path (for example, the CP path), the data encoding scheme, the data encryption scheme, and the like.
Step 5: The AMF sends the data collection request to the terminal by using a downlink DL NAS message.
Step 6: Interaction between data plane DP modules in the terminal.
Step 7: The terminal sends a response message by using an uplink UL NAS message.
Step 8: The terminal performs data collection or data processing.
Step 9: A service request triggered by the terminal.
Step 10: The terminal transmits collected data, for example, encoded data, via the CP path.
Step 11: The DPF performs data storage.
Step 12: The DPF sends the collected data to the data consumer device, that is, performs data notification (data notification).

In some implementations, when the data plane connection is based on a user plane path, the response message to the first request message further includes at least one of the following:
identification information corresponding to the user plane path;
address information or identification information of the first device corresponding to the user plane path; and
port information of the first device corresponding to the user plane path.

Specifically, when the data plane data forwarding path recommended by the second device to the first device, or selected by the first device itself, is the UP path or a protocol layer corresponding to the UP path,
the fourth path information for forwarding the data plane data selected by the first device and carried in the response message to the first request message is set as the UP path or the protocol layer corresponding to the UP path.

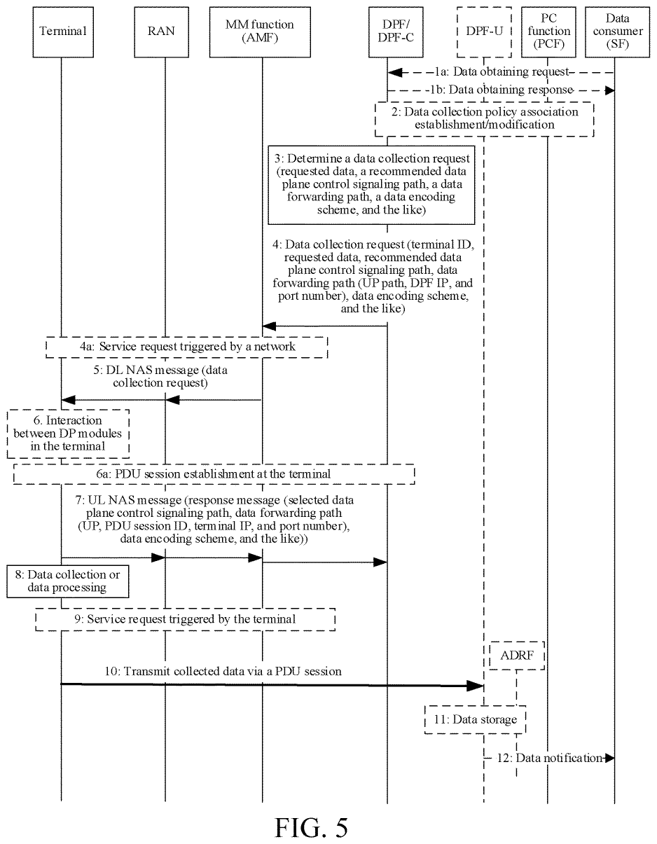

In some implementations, as shown in FIG. 5, the response message may further carry at least one of the following:
(a) identification information corresponding to the user plane UP path (for example, a PDU session ID (PDU session ID) or a QoS flow ID);
(b) address information or identification information of the first device corresponding to a data plane path, that is, address information or identification information allocated to the first device and corresponding to the UP path (for example, an IP address or an Ethernet address of the terminal); and
(c) port information of the first device corresponding to the data plane path, that is, port information allocated to the first device and corresponding to the UP path (for example, a port number (port num) of the terminal).

The information carried in the foregoing response message is used for notifying the second device that the first device forwards obtained data via the UP path.

Further, the first device (for example, the DP-U module) sends the obtained data to the target device (for example, the DPF-U) via the selected UP path.

For example, as shown in FIG. 5, the method includes:
Step 1a: The data consumer device sends a data obtaining request to the DPF (or the DPF-C).
Step 1b: The DPF (or the DPF-C) sends a data obtaining response to the data consumer device.
Step 2: Data collection policy association establishment/modification (data collection policy association establishment/modification).
Step 3: The DPF (or the DPF-C) determines a data collection request. For example, the data collection request includes at least one of the following: requested data, a recommended data plane control signaling path, a data forwarding path, a data encoding scheme, a data encryption scheme, and the like.
Step 4: The DPF (or the DPF-C) sends the data collection request to the AMF. For example, the data collection request includes at least one of the following: a terminal ID, the requested data, the recommended data plane control signaling path, the data forwarding path (for example, the UP path, a DPF IP, or a port number), the data encoding scheme, the data encryption scheme, or the like.
Step 5: The AMF sends the data collection request to the terminal by using a downlink DL NAS message.
Step 6: Interaction between data plane DP modules in the terminal.
Step 6a: PDU session establishment at the terminal.
Step 7: The terminal sends a response message by using an uplink UL NAS message.
Step 8: The terminal performs data collection or data processing.
Step 9: A service request triggered by the terminal.
Step 10: The terminal transmits collected data, for example, encoded data, via the PDU session.
Step 11: The DPF (or an ADRF) performs data storage.
Step 12: The DPF sends the collected data to the data consumer device, that is, performs data notification (data notification).

In some implementations, when the data plane connection is based on a data plane forwarding path, the response message to the first request message further includes at least one of the following:
identification information corresponding to a data plane path;
address information or identification information of the first device corresponding to the data plane path; and
port information of the first device corresponding to the data plane path.

Specifically, when the data plane data forwarding path recommended by the second device to the first device, or selected by the first device itself, is the DP path or a protocol layer corresponding to the DP path,
the data plane data forwarding path selected by the first device and carried in the response message to the first request message is set as the DP path or the protocol layer corresponding to the DP path.

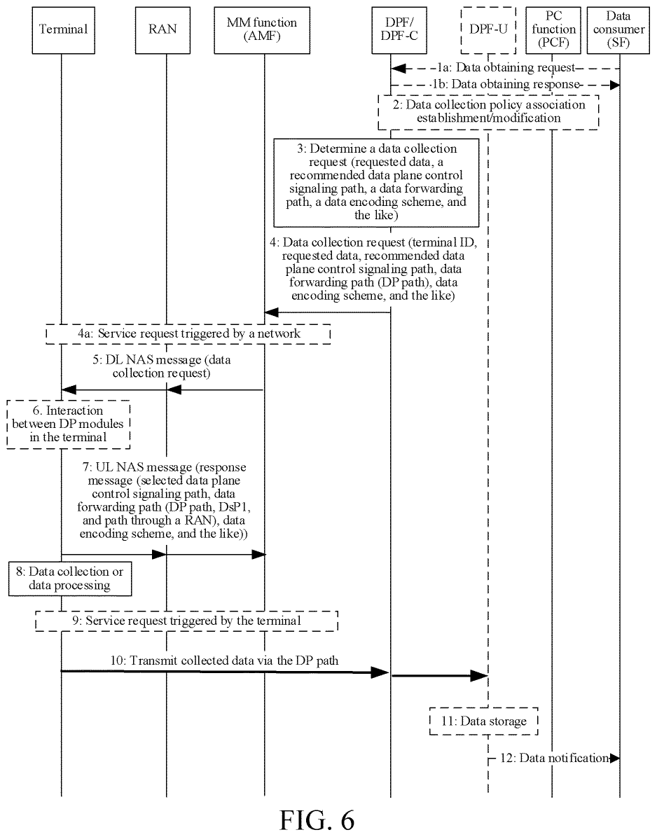

Further, in some implementations, as shown in FIG. 6, the response message may further carry at least one of the following:
(a) identification information corresponding to the DP path (for example, a DP session ID or a QoS flow ID);
(b) address information or identification information of the first device corresponding to a data plane path, for example, address information (for example, an IP address or an Ethernet address corresponding to a PDU session at the terminal) or identification information allocated to the first device and corresponding to the DP path; and
(c) port information of the first device corresponding to the data plane path, for example, port information allocated to the first device and corresponding to the DP path (for example, a port number of the terminal).

The information carried in the foregoing response message is used for notifying the second device that the first device forwards obtained data via the DP path.

Further, the first device (for example, the DP-U module) sends the obtained data to the second device (for example, the DPF-U) via the selected DP path.

For example, as shown in FIG. 6, the method includes:
Step 1a: The data consumer device sends a data obtaining request to the DPF (or the DPF-C).
Step 1b: The DPF (or the DPF-C) sends a data obtaining response to the data consumer device.
Step 2: Data collection policy association establishment/modification (data collection policy association establishment/modification).
Step 3: The DPF (or the DPF-C) determines a data collection request. For example, the data collection request includes at least one of the following: requested data, a recommended data plane control signaling path, a data forwarding path, a data encoding scheme, a data encryption scheme, and the like.
Step 4: The DPF (or the DPF-C) sends the data collection request to the AMF. For example, the data collection request includes at least one of the following: a terminal ID, the requested data, the recommended data plane control signaling path, the data forwarding path (for example, the DP path), the data encoding scheme, the data encryption scheme, or the like.
Step 5: The AMF sends the data collection request to the terminal by using a downlink DL NAS message.
Step 6: Interaction between data plane DP modules in the terminal.
Step 7: The terminal sends a response message by using an uplink UL NAS message, where the response message includes: a selected data plane control signaling path, a data forwarding path (for example, the DP path, DsP1, or a path through the RAN), a data encoding scheme, and the like.
Step 8: The terminal performs data collection or data processing.
Step 9: A service request triggered by the terminal.
Step 10: The terminal transmits collected data, for example, encoded data, via the DP path.
Step 11: The DPF performs data storage.
Step 12: The DPF sends the collected data to the data consumer device, that is, performs data notification (data notification).

In the foregoing examples of FIG. 4 to FIG. 6, the CP path is used in FIG. 4, the UP path is used in FIG. 5, and the DP path is used in FIG. 6.

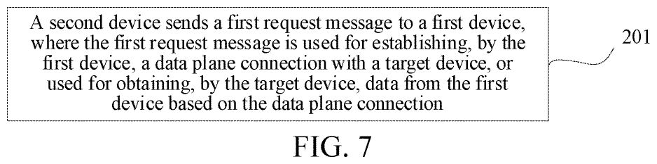

Refer to FIG. 7. An embodiment of this application provides a method for establishing a data plane connection. This embodiment is executed by a second device, and the method includes:
Step 201: The second device sends a first request message to a first device. The first request message is used for establishing, by the first device, a data plane connection with a target device, or used for obtaining, by the target device, data from the first device based on the data plane connection.

In some implementations, the first request message includes at least one of the following: first path information for data plane control signaling; second path information for forwarding data plane data; a first data encoding scheme; and a first data encryption scheme.

In some implementations, the method further includes:

The second device receives a response message to the first request message from the first device, where the response message to the first request message includes at least one of the following:
third path information for data plane control signaling;
fourth path information for forwarding data plane data;
a second data encoding scheme; and
a second data encryption scheme.

In some implementations, when the target device is the second device, the method further includes:

The second device receives data sent by the first device based on the data plane connection.

In some implementations, the method further includes:
the second device (a DPF-C) sends the data received from the first device to the target device (for example, a DPF-U). The beneficial effect is that the data is stored, so that when another data consumer subsequently needs to obtain the data, the second device can directly obtain the data from the target device without repeatedly obtaining the data from the first device.

In some implementations, the method further includes:

The second device determines the first request message.

In some implementations, the first path information or the third path information includes at least one of the following: control plane path indication information, user plane path indication information, data plane control path indication information, or information about a protocol layer through which data plane signaling is transferred.

In some implementations, the second path information or the fourth path information includes at least one of the following: control plane path indication information, user plane path indication information, data plane forwarding path indication information, or information about a protocol layer through which the data plane data is forwarded.

That the second device determines the first request message includes:

The second device determines the first path information for the data plane control signaling based on a first factor, where the first factor includes at least one of the following:
a forwarding latency requirement for the data plane control signaling; and
whether the data plane control signaling needs to be parsed by an access network device.

In some implementations, that the second device determines the first request message includes:

The second device determines the second path information for forwarding the data plane data based on a second factor, where the second factor includes at least one of the following:
a latency requirement for obtaining the data plane data;
an amount of to-be-transmitted data; and
whether the data plane data needs to be parsed by an access network device.

In some implementations, that the second device determines the first request message includes:

The second device determines the first data encoding scheme based on a third factor, where the third factor includes at least one of the following:
an encoding latency requirement for the data plane data;
an encoding efficiency requirement for the data plane data;
a readability requirement for the data plane data;
a security requirement for the data plane data; and
a reliability requirement for the data plane data.

In some implementations, the first request message further includes at least one piece of the following information about the data plane data:
a type of collected data;
data filtering information, used for performing filtering during data collection to obtain needed data;
data reporting condition information;
a data processing scheme; and
a data storage format, where
the data filtering information includes at least one of the following:
location restriction information for a data collection object;
time restriction information for data collection; and
service or application restriction information, used for restricting a service or an application that generates data; and
the data reporting condition information includes at least one of the following:
time periodicity information for data reporting; and
event information for triggering data reporting.

In some implementations, the first request message is determined by the second device based on at least one of data collection policy information for a data plane corresponding to the first device, a data request sent by a data consumer device, or requirement information of the second device.

In some implementations, the method further includes:

The second device obtains the data collection policy information from a third device, where
the data collection policy information includes at least one of the following:
data status;
anonymity indication information, indicating whether collected data is in an anonymous state;
a path type for data reporting, indicating a path type accepted or supported by the first device for data reporting;
an encoding scheme for data reporting; and
an encryption scheme for data reporting.

In some implementations, when the data plane connection is based on a user plane path, the response message to the first request message further includes at least one of the following:
identification information corresponding to the user plane path;
address information or identification information of the first device corresponding to the user plane path; and
port information of the first device corresponding to the user plane path.

In some implementations, when the data plane connection is based on a data plane forwarding path, the response message to the first request message further includes at least one of the following:
identification information corresponding to a data plane path;
address information or identification information of the first device corresponding to the data plane path; and
port information of the first device corresponding to the data plane path.

In some implementations, the method further includes:

The second device sends, to the target device, at least one of the following:
the first path information or the third path information;
the second path information or the fourth path information;
the first data encoding scheme or the second data encoding scheme;
the second data encryption scheme or the second data encryption scheme;
address information or identification information of the first device; and
port information of the first device.

In some implementations, the method further includes:

The second device (for example, the DPF-C) obtains second information of the target device (for example, the DPF-U), where
the second information includes at least one of the following: address information, identification information, and port information of the target device.

In some implementations, the second device sends the second information to the first device. For example, the second device may carry at least one of the address information, the identification information, and the port information of the target device (for example, the DPF-U) in the first request message.

Specific implementation processes and technical effects of the method in this embodiment are similar to those in the method embodiments on the first device side. For details, refer to detailed descriptions of the method embodiments on the first device side. The details are not described again herein.

The method for establishing a data plane connection provided in embodiments of this application may be executed by an apparatus for establishing a data plane connection. In embodiment of this application, the apparatus for establishing a data plane connection provided in embodiments of this application is described by using an example in which the method for establishing a data plane connection is executed by an apparatus for establishing a data plane connection.

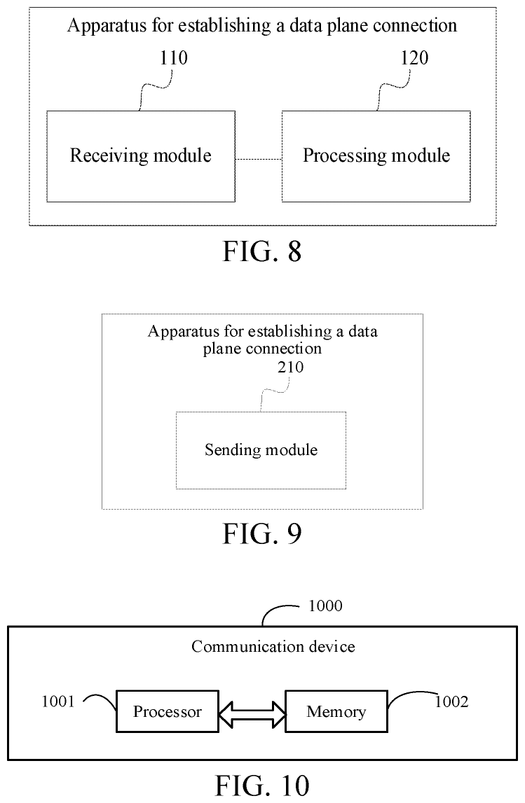

FIG. 8 is a first diagram of a structure of an apparatus for establishing a data plane connection according to an embodiment of this application. As shown in FIG. 8, the apparatus may be used in a first device. The apparatus for establishing a data plane connection provided in this embodiment includes:
a receiving module 110, configured to receive a first request message from a second device; and
a processing module 120, configured to establish a data plane connection with a target device based on the first request message.

In some implementations, the first request message includes at least one of the following: first path information for data plane control signaling; second path information for forwarding data plane data; a first data encoding scheme; and a first data encryption scheme.

In some implementations, the apparatus further includes:
a sending module, configured to send data to the target device based on the data plane connection.

In some implementations, the processing module 120 is further configured to:
determine first information based on the first request message.

In some implementations, the processing module 120 is specifically configured to:
establish the data plane connection with the target device based on the first information, where
the first information includes at least one of the following: third path information for data plane control signaling; fourth path information for forwarding the data plane data; a second data encoding scheme; and a second data encryption scheme.

In some implementations, the first path information or the third path information includes at least one of the following: control plane path indication information, user plane path indication information, data plane control path indication information, or information about a protocol layer through which data plane signaling is transferred.

In some implementations, the second path information or the fourth path information includes at least one of the following: control plane path indication information, user plane path indication information, data plane forwarding path indication information, or information about a protocol layer through which the data plane data is forwarded.

In some implementations, the processing module 120 is specifically configured to:
determine the third path information for the data plane control signaling based on a first factor, where the first factor includes at least one of the following:
a forwarding latency requirement for the data plane control signaling; and
whether the data plane control signaling needs to be parsed by an access network device.

In some implementations, the processing module 120 is specifically configured to:
determine the fourth path information for forwarding the data plane data based on a second factor, where the second factor includes at least one of the following:
a latency requirement for obtaining the data plane data;
an amount of to-be-transmitted data; and
whether the data plane data needs to be parsed by an access network device.

In some implementations, the processing module 120 is specifically configured to:
determine the second data encoding scheme based on a third factor, where the third factor includes at least one of the following:
an encoding latency requirement for the data plane data;
an encoding efficiency requirement for the data plane data;
a readability requirement for the data plane data;
a security requirement for the data plane data; and
a reliability requirement for the data plane data.

In some implementations, the first request message further includes at least one piece of the following information about the data plane data:
a type of collected data;
data filtering information, used for performing filtering during data collection to obtain needed data;
data reporting condition information;
a data processing scheme; and
a data storage format, where
the data filtering information includes at least one of the following:
location restriction information for a data collection object;
time restriction information for data collection; and
service or application restriction information, used for restricting a service or an application that generates data; and
the data reporting condition information includes at least one of the following:
time periodicity information for data reporting; and
event information for triggering data reporting.

In some implementations, the first request message is determined by the second device based on at least one of data collection policy information for a data plane corresponding to the first device, a data request sent by a data consumer device, or requirement information of the second device.

In some implementations, the sending module is further configured to:
send a response message to the first request message to the second device, where the response message to the first request message includes at least one of the following:
third path information for data plane control signaling;
fourth path information for forwarding data plane data;
a second data encoding scheme; and
a second data encryption scheme.

In some implementations, the sending module is specifically configured to:
send the data to the target device based on the fourth path information for forwarding the data plane data; and
before the sending the data to the target device, the sending module is specifically configured to perform at least one of the following:
encoding the data based on the second data encoding scheme; and
encrypting the data based on the second data encryption scheme.

In some implementations, when the data plane connection is based on a user plane path, the response message to the first request message further includes at least one of the following:
identification information corresponding to the user plane path;
address information or identification information of the first device corresponding to the user plane path; and
port information of the first device corresponding to the user plane path.

In some implementations, when the data plane connection is based on a data plane forwarding path, the response message to the first request message further includes at least one of the following:
identification information corresponding to a data plane path;
address information or identification information of the first device corresponding to the data plane path; and
port information of the first device corresponding to the data plane path.

In some implementations, the sending module is specifically configured to:
send the data to the target device based on the fourth path information for forwarding the data plane data and based on second information, where
the second information includes at least one of the following: address information, identification information, and port information of the target device.

In some implementations, the second information is obtained by the first device from the second device; or
the second information is obtained by the first device through a domain name system (DNS) query.

In some implementations, the receiving module 110 is specifically configured to:
receive, by a data plane control module of the first device, the first request message from the second device.

In some implementations, the processing module 120 is specifically configured to:
determine, by the data plane control module of the first device, the first information based on the first request message;
forward, by the data plane control module of the first device, the first information to a data plane forwarding module of the first device; and
establish, by the data plane forwarding module of the first device, the data plane connection with the target device based on the first information.

In some implementations, the sending module is specifically configured to:
send, by a data plane forwarding module of the first device, the data to the target device based on the data plane connection.

In some implementations, the first device includes at least one of a terminal and an access network device.

In some implementations, the second device includes at least one of an access network device and a core network device; and
the target device includes at least one of an access network device and a core network device.

The apparatus in this embodiment may be configured to execute processes of the foregoing method embodiments on the first device side method, and a specific implementation process and technical effects thereof are similar to those of the method embodiments on the first device side. For details, refer to the detailed descriptions of the method embodiments on the first device side. The details are not described herein again.

FIG. 9 is a second diagram of a structure of an apparatus for establishing a data plane connection according to an embodiment of this application. As shown in FIG. 9, the apparatus may be used in a second device. The apparatus for establishing a data plane connection provided in this embodiment includes:
a sending module 210, configured to send a first request message to a first device, where the first request message is used for establishing, by the first device, a data plane connection with a target device, or used for obtaining, by the target device, data from the first device based on the data plane connection.

In some implementations, the first request message includes at least one of the following: first path information for data plane control signaling; second path information for forwarding data plane data; a first data encoding scheme; and a first data encryption scheme.

In some implementations, the apparatus further includes:
a receiving module, configured to receive a response message to the first request message from the first device, where the response message to the first request message includes at least one of the following:
third path information for data plane control signaling;
fourth path information for forwarding data plane data;
a second data encoding scheme; and
a second data encryption scheme.

In some implementations, when the target device is the second device, the receiving module is further configured to:
receive data sent by the first device based on the data plane connection.

In some implementations, the apparatus further includes:
a processing module, configured to determine the first request message.

In some implementations, the first path information or the third path information includes at least one of the following: control plane path indication information, user plane path indication information, data plane control path indication information, or information about a protocol layer through which data plane signaling is transferred.

In some implementations, the second path information or the fourth path information includes at least one of the following: control plane path indication information, user plane path indication information, data plane forwarding path indication information, or information about a protocol layer through which the data plane data is forwarded.

In some implementations, the processing module is specifically configured to:
determine the first path information for the data plane control signaling based on a first factor, where the first factor includes at least one of the following:
a forwarding latency requirement for the data plane control signaling; and
whether the data plane control signaling needs to be parsed by an access network device.

In some implementations, the processing module is specifically configured to:
determine second path information for forwarding data plane data based on a second factor, where the second factor includes at least one of the following:
a latency requirement for obtaining the data plane data;
an amount of to-be-transmitted data; and
whether the data plane data needs to be parsed by an access network device.

In some implementations, the processing module is specifically configured to:
determine a first data encoding scheme based on a third factor, where the third factor includes at least one of the following:
an encoding latency requirement for the data plane data;
an encoding efficiency requirement for the data plane data;
a readability requirement for the data plane data;
a security requirement for the data plane data; and
a reliability requirement for the data plane data.

In some implementations, the first request message further includes at least one piece of the following information about the data plane data:
a type of collected data;
data filtering information, used for performing filtering during data collection to obtain needed data;
data reporting condition information;
a data processing scheme; and
a data storage format, where
the data filtering information includes at least one of the following:
location restriction information for a data collection object;
time restriction information for data collection; and
service or application restriction information, used for restricting a service or an application that generates data; and
the data reporting condition information includes at least one of the following:
time periodicity information for data reporting; and
event information for triggering data reporting.

In some implementations, the first request message is determined by the second device based on at least one of data collection policy information for a data plane corresponding to the first device, a data request sent by a data consumer device, or requirement information of the second device.

In some implementations, the processing module is further configured to:
obtain data collection policy information from a third device, where
the data collection policy information includes at least one of the following: data status;
anonymity indication information, indicating whether collected data is in an anonymous state;
a path type for data reporting, indicating a path type accepted or supported by the first device for data reporting;
an encoding scheme for data reporting; and
an encryption scheme for data reporting.

In some implementations, when the data plane connection is based on a user plane path, the response message to the first request message further includes at least one of the following:
identification information corresponding to the user plane path;
address information or identification information of the first device corresponding to the user plane path; and
port information of the first device corresponding to the user plane path.

In some implementations, when the data plane connection is based on a data plane forwarding path, the response message to the first request message further includes at least one of the following:
identification information corresponding to a data plane path;
address information or identification information of the first device corresponding to the data plane path; and
port information of the first device corresponding to the data plane path.

In some implementations, the sending module 210 is further configured to:
send, to the target device, at least one of the following:
the first path information or the third path information;
the second path information or the fourth path information;
the first data encoding scheme or the second data encoding scheme;
the second data encryption scheme or the second data encryption scheme;
address information or identification information of the first device; and
port information of the first device.

In some implementations, the receiving module is further configured to:
obtain second information of the target device;
the second information includes at least one of the following: address information, identification information, and port information of the target device.

The apparatus in this embodiment may be configured to perform the method in any one of the method embodiments on the second device side. Specific implementation processes and technical effects of the apparatus are similar to those in the method embodiments on the second device side. For details, refer to detailed descriptions in the method embodiments on the second device side. The details are not described herein again.

The apparatus for establishing a data plane connection in embodiments of this application may be an electronic device, for example, an electronic device having an operating system, or a component in an electronic device, for example, an integrated circuit or a chip. The electronic device may be a terminal or may be another device other than the terminal. For example, the terminal may include, but is not limited to, a type of the terminal 11 listed above, and the another device may be a server, a network attached storage (Network Attached Storage, NAS), or the like. This is not specifically limited in embodiments of this application.

The apparatus for establishing a data plane connection provided in embodiments of this application can implement processes implemented in the method embodiments of FIG. to FIG. 7, and achieve the same technical effects. To avoid repetition, details are not described herein.

As shown in FIG. 10, an embodiment of this application further provides a communication device 1000, including a processor 1001 and a memory 1002. The memory 1002 stores a program or instructions executable on the processor 1001. For example, when the communication device 1000 is a terminal, and when the program or the instructions are executed by the processor 1001, steps in the foregoing embodiments of the method for establishing a data plane connection are implemented, and the same technical effects can be achieved. When the communication device 1000 is a network side device, and when the programs or instructions are executed by the processor 1001, steps in the foregoing embodiments of the method for establishing a data plane connection are implemented, and the same technical effects are can achieved. To avoid repetition, details are not described herein again.

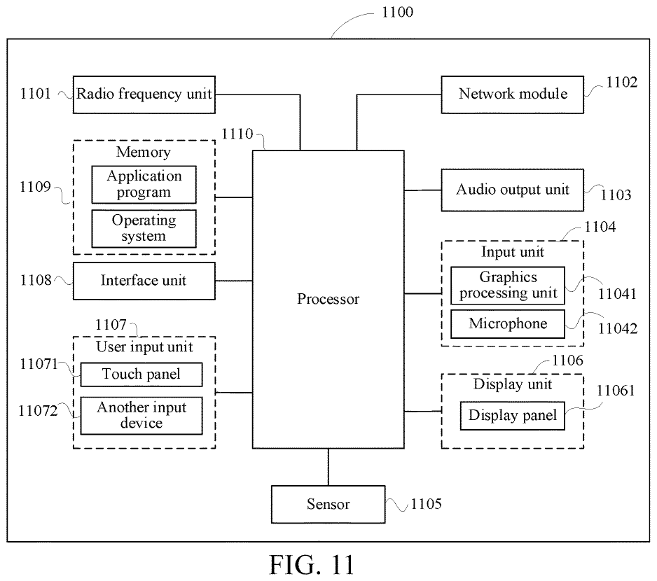

An embodiment of this application further provides a terminal, including a processor and a communication interface. The communication interface is coupled to the processor. The processor is configured to run a program or instructions, to implement the steps in the method embodiment shown in FIG. 3. The terminal embodiment corresponds to the foregoing method embodiment on the terminal side. Implementation processes and implementations of the foregoing method embodiments may all be applied to the terminal embodiment, and the same technical effects can be achieved. Specifically, FIG. 11 is a diagram of a hardware structure of a terminal for implementing this embodiment of this application.

The terminal 1100 includes, but is not limited to, at least some components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

It may be understood by a person skilled in the art that the terminal 1100 may further include a power supply (for example, a battery) for supplying power to the components. The power supply may be logically connected to the processor 1110 via a power management system, to implement functions such as charging, discharging, and power consumption management by using the power management system. The terminal structure shown in FIG. 11 constitutes no limitation on the terminal. The terminal may include more or fewer components than those shown in the figure, or some components may be combined, or component arrangements may be different. Details are not described herein.

It should be understood that in this embodiment of this application, the input unit 1104 may include a graphics processing unit (Graphics Processing Unit, GPU) 11041 and a microphone 11042. The graphics processing unit 11041 processes image data of a still picture or a video obtained by an image capture apparatus (for example, a camera) in a video capture mode or an image capture mode. The display unit 1106 may include a display panel 11061, and the display panel 11061 may be configured in a form of a liquid crystal display, an organic light-emitting diode, or the like. The user input unit 1107 includes at least one of a touch panel 11071 and another input device 11072. The touch panel 11071 may also be referred to as a touch screen. The touch panel 11071 may include two parts: a touch detection apparatus and a touch controller. The another input device 11072 may include, but is not limited to, a physical keyboard, a functional key (for example, a volume control key or a switch key), a trackball, a mouse, and a joystick. Details are not described herein.

In this embodiment of this application, after receiving downlink data from a network side device, the radio frequency unit 1101 may transmit the downlink data to the processor 1110 for processing. In addition, the radio frequency unit 1101 may send uplink data to the network side device. Generally, the radio frequency unit 1101 includes, but is not limited to, an antenna, an amplifier, a transceiver, a coupler, a low noise amplifier, a duplexer, and the like.

The memory 1109 may be configured to store a software program or instructions and various data. The memory 1109 may mainly include a first storage area storing a program or instructions and a second storage area storing data. The first storage area may store an operating system, an application or instructions (such as an audio playback function or an image playback function) required for at least one function, and the like. In addition, the memory 1109 may include a volatile memory or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DR RAM). The memory 1109 in this embodiment of this application includes, but is not limited to, these memories and any other suitable types of memories.

The processor 1110 may include one or more processing units. In some implementations, an application processor and a modem processor are integrated into the processor 1110. The application processor mainly processes operations related to an operating system, a user interface, an application, and the like. The modem processor mainly processes a wireless communication signal, for example, may be a baseband processor. It may be understood that the modem processor may alternatively not be integrated into the processor 1110.

The radio frequency unit 1101 is configured to receive a first request message from a second device.

The processor 1110 is configured to establish a data plane connection with a target device based on the first request message.

In some implementations, the first request message includes at least one of the following: first path information for data plane control signaling; second path information for forwarding data plane data; a first data encoding scheme; and a first data encryption scheme.

In some implementations, the radio frequency unit 1101 is further configured to:
send data to the target device based on the data plane connection.

In some implementations, the processor 1110 is further configured to:
determine first information based on the first request message;

In some implementations, the processor 1110 is specifically configured to:
establish the data plane connection with the target device based on the first information, where
the first information includes at least one of the following: third path information for data plane control signaling; fourth path information for forwarding the data plane data; a second data encoding scheme; and a second data encryption scheme.

In some implementations, the first path information or the third path information includes at least one of the following: control plane path indication information, user plane path indication information, data plane control path indication information, or information about a protocol layer through which data plane signaling is transferred.

In some implementations, the second path information or the fourth path information includes at least one of the following: control plane path indication information, user plane path indication information, data plane forwarding path indication information, or information about a protocol layer through which the data plane data is forwarded.

In some implementations, the processor 1110 is specifically configured to:
determine the third path information for the data plane control signaling based on a first factor, where the first factor includes at least one of the following:
a forwarding latency requirement for the data plane control signaling; and
whether the data plane control signaling needs to be parsed by an access network device.

In some implementations, the processor 1110 is specifically configured to:
determine the fourth path information for forwarding the data plane data based on a second factor, where the second factor includes at least one of the following:
a latency requirement for obtaining the data plane data;
an amount of to-be-transmitted data; and
whether the data plane data needs to be parsed by an access network device.

In some implementations, the processor 1110 is specifically configured to:
determine the second data encoding scheme based on a third factor, where the third factor includes at least one of the following:
an encoding latency requirement for the data plane data;
an encoding efficiency requirement for the data plane data;
a readability requirement for the data plane data;
a security requirement for the data plane data; and
a reliability requirement for the data plane data.

In some implementations, the first request message further includes at least one piece of the following information about the data plane data:
a type of collected data;
data filtering information, used for performing filtering during data collection to obtain needed data;
data reporting condition information;
a data processing scheme; and
a data storage format, where
the data filtering information includes at least one of the following:
location restriction information for a data collection object;
time restriction information for data collection; and
service or application restriction information, used for restricting a service or an application that generates data; and
the data reporting condition information includes at least one of the following:
time periodicity information for data reporting; and
event information for triggering data reporting.

In some implementations, the first request message is determined by the second device based on at least one of data collection policy information for a data plane corresponding to the first device, a data request sent by a data consumer device, or requirement information of the second device.

In some implementations, the radio frequency unit 1001 is further configured to:
send a response message to the first request message to the second device, where the response message to the first request message includes at least one of the following:
third path information for data plane control signaling;
fourth path information for forwarding data plane data;
a second data encoding scheme; and
a second data encryption scheme.

In some implementations, the radio frequency unit 1001 is specifically configured to:
send the data to the target device based on the fourth path information for forwarding the data plane data; and
before the sending the data to the target device, the processor 1010 is specifically configured to perform at least one of the following:
encoding the data based on the second data encoding scheme; and
encrypting the data based on the second data encryption scheme.

In some implementations, when the data plane connection is based on a user plane path, the response message to the first request message further includes at least one of the following:
identification information corresponding to the user plane path;
address information or identification information of the first device corresponding to the user plane path; and
port information of the first device corresponding to the user plane path.

In some implementations, when the data plane connection is based on a data plane forwarding path, the response message to the first request message further includes at least one of the following:
identification information corresponding to a data plane path;
address information or identification information of the first device corresponding to the data plane path; and
port information of the first device corresponding to the data plane path.

In some implementations, the sending module is specifically configured to:
send the data to the target device based on the fourth path information for forwarding the data plane data and based on second information, where
the second information includes at least one of the following: address information, identification information, and port information of the target device.

In some implementations, the second information is obtained by the first device from the second device; or
the second information is obtained by the first device through a domain name system (DNS) query.

In some implementations, the radio frequency unit 1001 is specifically configured to:
receive, by a data plane control module of the first device, the first request message from the second device.

In some implementations, the processor 1010 is specifically configured to:
determine, by the data plane control module of the first device, the first information based on the first request message;
forward, by the data plane control module of the first device, the first information to a data plane forwarding module of the first device; and
establish, by the data plane forwarding module of the first device, the data plane connection with the target device based on the first information.

In some implementations, the radio frequency unit 1001 is specifically configured to:
send, by a data plane forwarding module of the first device, the data to the target device based on the data plane connection.

In some implementations, the first device includes at least one of a terminal and an access network device.

In some implementations, the second device includes at least one of an access network device and a core network device; and
the target device includes at least one of an access network device and a core network device.

It may be understood that, for the implementation processes of the implementations mentioned in this embodiment, refer to related descriptions of the method embodiment shown in FIG. 3, and the same or corresponding technical effects are achieved. To avoid repetition, details are not described herein again.

An embodiment of this application further provides a network side device, including a processor and a communication interface. The communication interface is coupled to the processor. The processor is configured to run a program or instructions, to implement steps in the method embodiment shown in FIG. 3 or FIG. 7. The network side device embodiment corresponds to the foregoing method embodiments on the network side device. Both implementation processes and implementations of the foregoing method embodiments are applicable to the network side device embodiment, and the same technical effects can be achieved.

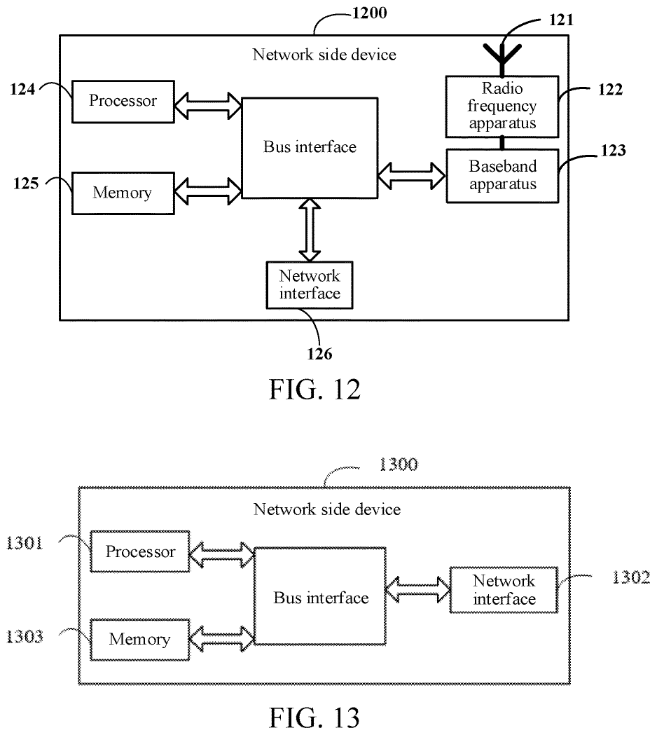

Specifically, an embodiment of this application further provides a network side device. As shown in FIG. 12, the network side device 1200 includes an antenna 121, a radio frequency apparatus 122, a baseband apparatus 123, a processor 124, and a memory 125. The antenna 121 is connected to the radio frequency apparatus 122. In an uplink direction, the radio frequency apparatus 122 receives information through the antenna 121, and sends the received information to the baseband apparatus 123 for processing. In a downlink direction, the baseband apparatus 123 processes to-be-sent information and sends the to-be-sent information to the radio frequency apparatus 122, and the radio frequency apparatus 122 processes received information and sends out the information through the antenna 121.

The method performed by the network side device in the foregoing embodiments may be implemented in the baseband apparatus 123. The baseband apparatus 123 includes a baseband processor.

The baseband apparatus 123 may include, for example, at least one baseband board. A plurality of chips are provided on the baseband board. As shown in FIG. 12, one of the chips is, for example, a baseband processor, and is connected to the memory 125 via a bus interface to call a program in the memory 125, so as to perform network device operations described in the foregoing method embodiments.

The network side device may further include a network interface 126, and the interface, for example, is a common public radio interface (CPRI).

Specifically, the network side device 1200 in this embodiment of this application further includes: instructions or a program stored in the memory 125 and executable on the processor 124. The processor 124 calls the instructions or the program stored in the memory 125 to perform the method executed by modules shown in FIG. 8 or FIG. 9, and can achieve the same technical effects. To avoid repetition, details are not described herein again.

Specifically, an embodiment of this application further provides a network side device. As shown in FIG. 13, the network side device 1300 includes a processor 1301, a network interface 1302, and a memory 1303. The network interface 1302 may be, for example, a common public radio interface (CPRI).

Specifically, the network side device 1300 in this embodiment of this application further includes instructions or a program stored in the memory 1303 and executable on the processor 1301. The processor 1301 calls the instructions or the program stored in the memory 1303 to perform the method performed by modules shown in FIG. 9, and the same technical effects are achieved. To avoid repetition, details are not described herein again.

An embodiment of this application further provides a readable storage medium. A program or instructions are stored in the readable storage medium. When the program or the instructions are executed by a processor, processes of the method for establishing a data plane connection in the foregoing embodiments can be implemented, and the same technical effects can be achieved. To avoid repetition, details are not described herein again.

The processor is a processor in the terminal in the foregoing embodiments. The readable storage medium includes a computer-readable storage medium, for example, a computer read-only memory (ROM), a random access memory (RAM), a magnetic disk, or an optical disc. In some examples, the readable storage medium may be a non-transitory readable storage medium.

An embodiment of this application further provides a chip. The chip includes a processor and a communication interface. The communication interface is coupled to the processor. The processor is configured to run a program or instructions to implement processes of the method for establishing a data plane connection in the foregoing embodiments, and the same technical effects can be achieved. To avoid repetition, details are not described herein again.

It should be understood that the chip mentioned in this embodiment of this application may also be referred to as a system-on-chip, a system chip, a chip system, a system-on-a-chip, or the like.

An embodiment of this application further provides a computer program/a computer program product, stored in a storage medium. The computer program/the computer program product is executed by at least one processor to implement processes of the method for establishing a data plane connection in the foregoing embodiments and achieve the same technical effects. To avoid repetition, details are not described herein again.

An embodiment of this application further provides a communication system. The system includes a first device and a second device. The first device may be configured to perform steps of the method for establishing a data plane connection. The second device may be configured to perform steps of the method for establishing a data plane connection.

It should be noted that, the terms “include”, “comprise”, or any other variation thereof in this specification are intended to cover non-exclusive inclusion, so that a process, method, article, or apparatus that includes a series of elements includes not only those elements, but also other elements that are not explicitly listed or elements inherent to the process, method, article, or apparatus. Without more limitations, an element preceded by a phrase “including a . . . ” does not exclude that there are additional same elements in the process, method, article, or apparatus. In addition, it should be noted that the scope of the method and apparatus in embodiments of this application is not limited to implementing functions in an order shown or discussed, and may further include implementing functions in a basically simultaneous manner or in a reverse order according to related functions. For example, the described method may be performed in an order different from the described order, and various steps may be added, omitted, or combined. In addition, features described in some examples may be combined in another example.

According to the descriptions in the foregoing implementations, a person skilled in the art may clearly understand that the method in the foregoing embodiments may be implemented by using a computer software product and a necessary universal hardware platform, or may certainly be implemented by using hardware. The computer software product is stored in a storage medium (for example, a ROM, a RAM, a magnetic disk, or an optical disc), and includes several instructions, to cause a terminal or a network side device to perform the method described in embodiments of this application.

The foregoing describes embodiments of this application with reference to the accompanying drawings. However, this application is not limited to the foregoing specific implementations. The foregoing specific implementations are merely examples, but are not limitative. A person of ordinary skill in the art may further make various implementations under the teaching of this application without departing from the purposes and the protection scope of the claims of this application, and all the implementations shall fall within the protection of this application.

What is claimed is:

1. A method for establishing a data plane connection, performed by a first device, comprising:
receiving a first request message from a second device; and
establishing a data plane connection with a target device based on the first request message.

2. The method according to claim 1, wherein the first request message comprises at least one of the following:
first path information for data plane control signaling;
second path information for forwarding data plane data;
a first data encoding scheme; or
a first data encryption scheme.

3. The method according to claim 1, further comprising:
sending data to the target device based on the data plane connection.

4. The method according to claim 2, further comprising:
determining first information based on the first request message,
wherein the establishing a data plane connection with a target device based on the first request message comprises:
establishing the data plane connection with the target device based on the first information, wherein the first information comprises at least one of the following:
third path information for data plane control signaling;
fourth path information for forwarding data plane data;
second data encoding scheme; or
a second data encryption scheme.

5. The method according to claim 4, wherein the first path information or the third path information comprises at least one of the following:
control plane path indication information;
user plane path indication information;
data plane control path indication information; or
information about a protocol layer through which data plane signaling is transferred.

6. The method according to claim 4, wherein the second path information or the fourth path information comprises at least one of the following:
control plane path indication information;
user plane path indication information;
data plane forwarding path indication information; or
information about a protocol layer through which the data plane data is forwarded.

7. The method according to claim 4, wherein the determining first information based on the first request message comprises:
determining the third path information for the data plane control signaling based on a first factor, wherein the first factor comprises at least one of the following:
a forwarding latency requirement for the data plane control signaling; or
whether the data plane control signaling needs to be parsed by an access network device.

8. The method according to claim 4, wherein the determining first information based on the first request message comprises:
determining the fourth path information for forwarding the data plane data based on a second factor, wherein the second factor comprises at least one of the following:
a latency requirement for obtaining the data plane data;
an amount of to-be-transmitted data; or
whether the data plane data needs to be parsed by an access network device.

9. The method according to claim 4, wherein the determining first information based on the first request message comprises:
determining the second data encoding scheme based on a third factor, wherein the third factor comprises at least one of the following:
an encoding latency requirement for the data plane data;
an encoding efficiency requirement for the data plane data;
a readability requirement for the data plane data;
a security requirement for the data plane data; or
a reliability requirement for the data plane data.

10. The method according to claim 1, wherein
the first request message further comprises at least one piece of the following information about the data plane data:
a type of collected data;
data filtering information, used for performing filtering during data collection to obtain needed data;
data reporting condition information;
a data processing scheme; or
a data storage format,
wherein the data filtering information comprises at least one of the following:
location restriction information for a data collection object;
time restriction information for data collection; or
service or application restriction information, used for restricting a service or an application that generates data, and
wherein the data reporting condition information comprises at least one of the following:
time periodicity information for data reporting; or
event information for triggering data reporting.

11. The method according to claim 1, wherein
the first request message is determined by the second device based on at least one of data collection policy information for a data plane corresponding to the first device, a data request sent by a data consumer device, or requirement information of the second device.

12. The method according to claim 3, further comprising:
sending a response message to the first request message to the second device, wherein the response message to the first request message comprises at least one of the following:
third path information for data plane control signaling;
fourth path information for forwarding data plane data;
a second data encoding scheme; or
a second data encryption scheme.

13. The method according to claim 12, wherein the sending data to the target device based on the data plane connection comprises:
sending the data to the target device based on the fourth path information for forwarding the data plane data; and
before the sending the data to the target device, the method further comprises at least one of the following:
encoding the data based on the second data encoding scheme; or
encrypting the data based on the second data encryption scheme.

14. The method according to claim 12, wherein
when the data plane connection is based on a user plane path, the response message to the first request message further comprises at least one of the following:
identification information corresponding to the user plane path;
address information or identification information of the first device corresponding to the user plane path; or
port information of the first device corresponding to the user plane path.

15. The method according to claim 12, wherein
when the data plane connection is based on a data plane forwarding path, the response message to the first request message further comprises at least one of the following:
identification information corresponding to a data plane path;
address information or identification information of the first device corresponding to the data plane path; or
port information of the first device corresponding to the data plane path.

16. The method according to claim 13, wherein the sending the data to the target device based on the fourth path information for forwarding the data plane data comprises:
sending the data to the target device based on the fourth path information for forwarding the data plane data and based on second information, wherein
the second information comprises at least one of the following:
address information, identification information, or port information of the target device, wherein
the second information is obtained by the first device from the second device; or
the second information is obtained by the first device through a Domain Name System (DNS) query.

17. The method according to claim 4, wherein the receiving a first request message from a second device comprises:
receiving, by a data plane control module of the first device, the first request message from the second device;
the determining first information based on the first request message comprises:
determining, by the data plane control module of the first device, the first information based on the first request message; and
forwarding, by the data plane control module of the first device, the first information to a data plane forwarding module of the first device; and
the establishing a data plane connection with a target device based on the first request message comprises:
establishing, by the data plane forwarding module of the first device, the data plane connection with the target device based on the first information.

18. A method for establishing a data plane connection, performed by a second device, comprising:
sending a first request message to a first device, wherein
the first request message is used for establishing, by the first device, a data plane connection with a target device, or used for obtaining, by the target device, data from the first device based on the data plane connection.

19. A first device, comprising:
a memory storing computer-readable instructions; and
a processor coupled to the memory and configured to execute the computer-readable instructions, wherein the computer-readable instructions, when executed by the processor, cause the processor to perform the method for establishing a data plane connection according to claim 1.

20. A second device, comprising:
a memory storing computer-readable instructions; and
a processor coupled to the memory and configured to execute the computer-readable instructions, wherein the computer-readable instructions, when executed by the processor, cause the processor to perform the method for establishing a data plane connection according to claim 18.
